(19) United States
(12) Patent Application Publication
(10) Pub. No.: US 2009/0242285 A1
(43) Pub. Date: Oct. 1, 2009

(54) TRANSPORTATION CART WITH EXTENDABLE ARM AND A THROTTLE COUPLED THERETO FOR CONTROLLING A MOTOR AND ASSOCIATED METHODS

(76) Inventor: Henry M. Whetstone, JR., St. Augustine, FL (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(21) Appl. No.: 12/434,351

(22) Filed: May 1, 2009

Related U.S. Application Data
(63) Continuation-in-part of application No. 12/060,857, filed on Apr. 1, 2008.

(51) Int. Cl. B62D 51/04; B23P 11/00

(52) U.S. Cl. 180/19.2; 29/428

(57) ABSTRACT

A vehicle is for riding and walking modes of use and includes at least one seat coupled to a frame. A plurality of wheels are rotatably coupled to the frame. At least one motor is for driving at least one wheel of the plurality thereof. A steering assembly is coupled to at least one wheel of the plurality thereof. A riding steering apparatus is coupled to the steering assembly for the riding mode of use. A riding throttle is coupled to the at least one motor for the riding mode of use. A walking steering apparatus is coupled to the steering assembly for the walking mode of use and includes an extendable arm. A walking throttle is coupled to the extendable arm to control the at least one motor for the walking mode of use based upon extension of the extendable arm.

### RELATED APPLICATIONS

The present application is a continuation-in-part of U.S. patent application Ser. No. 12/060,857 filed Apr. 1, 2008, the entire subject matter of which is incorporated herein by reference in its entirety.

### FIELD OF THE INVENTION

This invention generally relates to transportation, and more particularly, to a vehicle designed for either walking or riding modes of use and configured to transport one or more passengers, such as a golfer, and/or items, such as baggage.

### BACKGROUND OF THE INVENTION

Personal transportation vehicles, such as golf carts, are commonplace. They are typically used where use of conventional automobiles is impractical. For example, they may be used in industrial facilities, airports, parks and communities; although, they are best known for service on a golf course. While such vehicles have proven to be very effective for transporting people and small loads within limited range, they typically may not be configured to allow an operator to safely walk with the vehicle. This is a shortcoming because there are many occasions when an operator may want to walk with the vehicle, such as for purposes of exercise, careful maneuvering and increased visibility, and loading the vehicle to maximum capacity.

As one example, many golfers prefer walking at least part of the way during a round of golf. However, due to fatigue, age, health conditions, physical limitations, weather conditions, difficult terrain or other reasons, they either are simply incapable or prefer not to walk an entire course. Unfortunately, heretofore golfers have been constrained to choosing between walking or riding, before commencing a round of golf. A conventional motorized golf cart may be driven all the way around the course, eliminating any beneficial walking exercise. The alternative requires carrying a heavy bag, retaining an able-bodied assistant (i.e., a caddie) to carry the bag, or using a cart, whether a push, pull or motorized type, to carry the heavy bag, while the golfer commits to walking the entire course.

To address the need for a walking and riding golf cart, several walk and ride carts have been devised. Most of these dual-use (i.e., walk and ride) carts provide steering and power controls that are adjustable (e.g., extendible or pivoting) to facilitate access while walking or riding. For example, U.S. Pat. No. 5,346,028 and PCT Application WO2006032275 disclose an electric motorized cart equipped with a telescopically extendible steering column, which allows one to ride the cart or extend the column and walk behind the cart. The golf cart is controlled in the same manner, using the same controls and modes of use, when riding and walking. Similarly, European Patent EP1316334 and UK Patent GB2242404 disclose a cart with a pivoting steering assembly that allows the cart to be operated by a person sitting on the cart or pivoted forward for operation by a person walking in front of the cart. Some carts are chariot-style walk or ride devices, such as U.S. Pat. Nos. 4,538,695, 4,874,055 and 7,086,491 and PCT Application WO2006032275. Again, these carts are controlled in the same manner, using the same controls and modes of use, when riding and walking. However, further advances in vehicles for walking and riding modes of use may be desirable.

### SUMMARY OF THE INVENTION

In view of the foregoing background, it is therefore an object of the present invention to provide a vehicle for walking and riding modes of use with increased ease of use.

This and other objects, features, and advantages in accordance with the present invention are provided by a vehicle for riding and walking modes of use that may comprise a frame and at least one seat coupled to the frame. In addition, a plurality of wheels may be rotatably coupled to the frame. At least one motor may drive at least one wheel of the plurality thereof. A steering assembly may be coupled to at least one wheel of the plurality thereof. A riding steering apparatus may be coupled to the steering assembly for the riding mode of use and a riding throttle may be coupled to the at least one motor for the riding mode of use.

A walking steering apparatus may be coupled to the steering assembly for the walking mode of use and may comprise an extendable arm. In addition, a walking throttle may be coupled to the extendable arm to control the at least one motor for the walking mode of use based upon extension of the extendable arm.

The extendable arm may comprise a plurality of telescoping members. The walking steering apparatus may further comprise a biasing member to bias the extendable arm in a retracted position. The walking throttle may comprise a throttle sensor coupled to the extendable arm to detect extension thereof.

The throttle sensor may comprise a potentiometer. A lockout switch may be carried by the walking steering apparatus to enable the walking throttle based upon contact with a user's hand. The walking steering apparatus may be movable from a stowed position to an operational position. The riding throttle may be disabled when the walking steering apparatus is in the operational position. The walking throttle may be disabled when the walking steering apparatus is in the stowed position. A controller may be coupled to the riding throttle, the walking throttle, and the at least one motor and may limit a speed of the at least one motor based upon the mode of use.

The vehicle may have a braking system. A riding brake may be coupled to the braking system for the riding mode of use and a walking brake may be coupled to the extendable arm to control the braking system for the walking mode of use and based upon extension of the extendable arm.

The walking steering apparatus may be movable from a stowed position to an operational position. The riding brake may be disabled when the walking steering apparatus is in the operational position and the walking brake may be disabled when the walking steering apparatus is in the stowed position.

The riding brake may be electrically coupled to the controller and the walking brake may be electrically coupled to the controller. The braking system may comprise a regenerative braking system and a rechargeable power supply may be carried by the frame and coupled to the regenerative braking system. Additionally or alternatively, the braking system may comprise a friction braking system.

The vehicle may further comprise a riding forward-neutral-reverse switch carried by the frame and coupled to the at least one motor and a walking forward-neutral-reverse switch carried by the walking steering apparatus and coupled to the at least one motor. The frame may have a front end and a rear end, and the plurality of wheels may comprise a pair of rear wheels carried by the rear end, and a pair of front wheels carried by the front end. The steering assembly may be coupled to the pair of front wheels. The at least one motor may drive the pair of rear wheels.

Another aspect may be directed to a method of making a vehicle for riding and walking modes of use. The method may comprise coupling at least one seat coupled to a frame and rotatably coupling a plurality of wheels to the frame. In addition, the method may include coupling at least one wheel of the plurality thereof to at least one motor and coupling a steering assembly to at least one wheel of the plurality thereof. A riding steering apparatus may be coupled to the steering assembly for the riding mode of use. A riding throttle may be coupled to the at least one motor for the riding mode of use. A walking steering apparatus may be coupled to the steering assembly for the walking mode of use and comprising an extendable arm. A walking throttle may be coupled to the extendable arm to control the at least one motor for the walking mode of use based upon extension of the extendable arm.

### BRIEF DESCRIPTION OF THE DRAWINGS

The foregoing and other aspects, objects, features and advantages of the invention will become better understood with reference to the following description, appended claims, and accompanying drawings, where:

FIG. 1 shows a side view of a vehicle according to the present invention.

FIG. 2 shows a perspective schematic view of the vehicle of FIG. 1.

FIG. 2A shows a perspective schematic view of the steering apparatus of the vehicle of FIG. 1.

FIG. 2B shows a perspective schematic view of the motor and rear wheels of the vehicle of FIG. 1.

FIG. 3 shows an alternative perspective schematic view of the vehicle of FIG. 1.

FIG. 4 shows a schematic perspective view of an alternative embodiment of a vehicle according to the present invention.

FIG. 5 shows a schematic view of components of an exemplary braking system for with a vehicle according to the present invention.

FIG. 5A shows various walking operational and non-operational ranges for the vehicle according to the present invention.

FIG. 6 shows a high level schematic of a riding electronic control system for the vehicle of FIG. 1.

FIG. 7 shows a high level schematic of a walking electronic control system for the vehicle of FIG. 1.

FIG. 8A shows a perspective view of a walking arm (walking steering apparatus) in an extended position for use with a vehicle in accordance with the present invention.

FIG. 8B shows a perspective view the walking arm (walking steering apparatus) of FIG. 8A in a retracted position.

FIG. 9 shows a top plan schematic view of a walking steering apparatus comprising an extendable arm for use with a vehicle in accordance with the present invention in a fully retracted position.

FIG. 10 shows a top plan schematic view of the walking steering apparatus of FIG. 9 in a partially extended position.

FIG. 11 shows a top plan schematic view of the walking steering apparatus of FIG. 9 in a fully extended position.

Those skilled in the art will appreciate that the figures are not intended to be drawn to any particular scale; nor are the figures intended to illustrate every embodiment of the invention. The invention is not limited to the exemplary embodiments depicted in the figures or the specific components, shapes, relative sizes, ornamental aspects or proportions shown in the figures.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime notation is used to indicate similar elements in different embodiments.

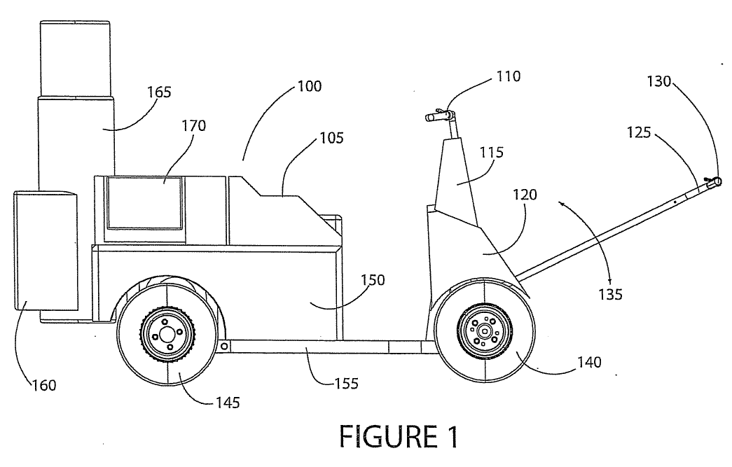

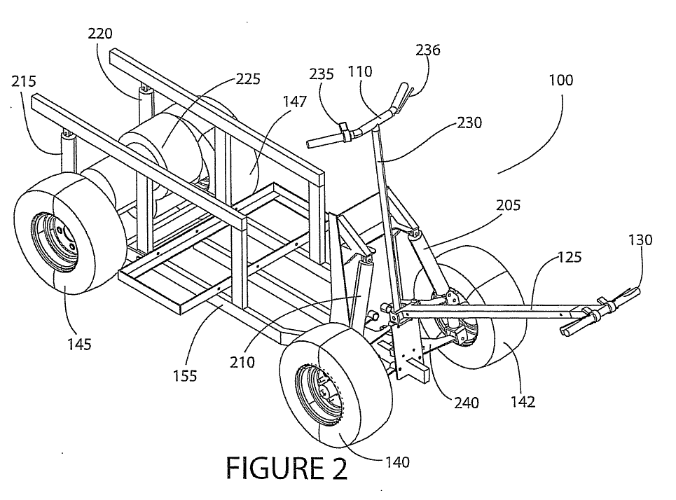

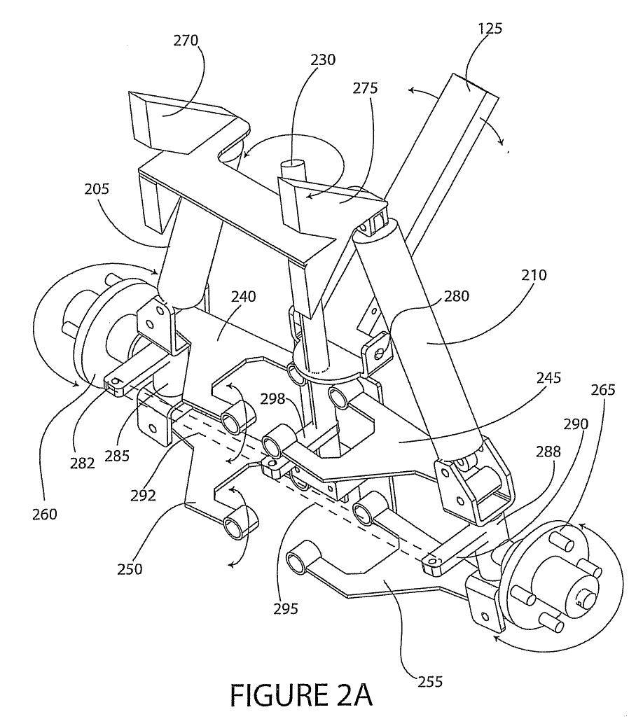

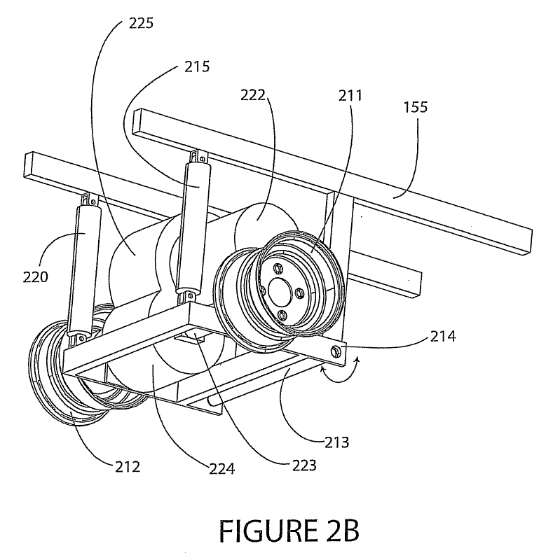

Referring specifically to FIG. 1, a profile of an exemplary dual mode of use vehicle 100, configured for either walking or riding modes of use, and configured to transport one or more passengers, such as a golfer, and/or items, such as baggage, according to principles of the invention, is provided. The vehicle 100 includes a frame 155, a plurality of wheels 140, 142, 145 and 147 (as shown in FIG. 2), a pivoting 135 walking arm 125 (also called a walking steering apparatus) with controls 130 for walking mode use, a handlebar 110 for steering during riding, a console 115 with a fairing, a front nose and fender fairing 120, left and right side fender fairings 150, a seat 105, a storage compartment 170, and a holder 160 for a golf bag 165.

The walking arm 125 may be stowed when not in use. Illustratively, the walking arm 125 may be pivoted upward when not in use, to an axial position that is either substantially parallel or in-line with the steering column 230 (as shown in FIG. 2) rotational axis. The walking arm 125 provides a safe distance between the operator and the vehicle's front tires 140, 142. Because the elongated walking arm 125 may impede a seated driver's line-of-sight when rotated upward or stowed, in an alternative embodiment the walking arm 125 may be collapsible. For example, the arm 125 may be constructed using telescopic or folding sections.

As discussed more fully below, the exemplary vehicle 100 has two separate motor controller modes of operation, one for riding mode and one for walking mode. Each mode of operation has pre-determined limits for maximum speed, motor current, acceleration, deceleration, and braking. A feedback sensor 690 on the motor 222 provides input to the motor controller 600 to limit maximum speed in each mode. In riding mode, the maximum speed of operation may be limited to conventional speeds allowed by golf carts, which may range from 10 to 14 miles per hour. In walking mode, the maximum speed may be limited to a brisk walking pace, which may range from 3 to 4 miles per hour. The vehicle 100 has two separate sets of throttle 616, 720 and brake controls. One set is used in riding mode and the other is used in walking mode.

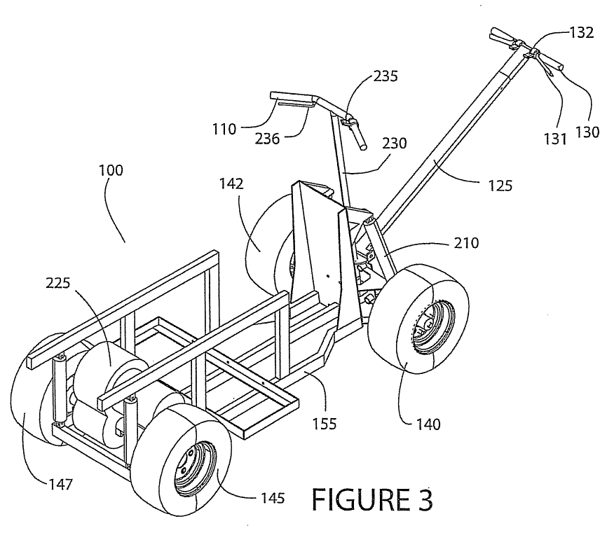

Referring now to FIGS. 2 and 3, perspective views of components of the exemplary dual mode of use vehicle, are provided. To better illustrate the frame, motor and suspension, all fairings, fenders, exterior panels, compartments, the seat, and holder are omitted. The frame 155 comprises a framework of connected durable, rigid support beams, to which the steering, suspension, braking and motor are operably coupled. So long as the frame 155 provides adequate support for all supported components (e.g., the motor and suspension, fairings, fenders, exterior panels, the seat, and holder), then the particular configuration and arrangement of support beams comprising the frame 155 is not particularly important and the invention is not limited to a particular frame configuration or arrangement. Frame configurations and arrangements other than as depicted are feasible and come within the scope of the invention.

The vehicle has two separate steering devices, a riding steering device used while a driver is seated on the vehicle and a walking steering device used while the operator walks in front of the vehicle. Controls, such as one or more throttle control 132, 235 and one or more brake actuators 131, 236 may be provided on the steering devices. Any compatible vehicle steering system may be used with a cart 100 according to principles of the invention. With reference to FIG. 2A, steering may, for example, be accomplished by rotating a steering column 230, which is operably coupled to the front wheels 140, 142 via steering components and linkages, such as steering knuckles 282, 290, 298 and tie rods 292, 295 (shown in dotted lines for clarity). Steering by exerting a rotational force either via the handlebars 110 (or a steering wheel) while riding or via the pivotally coupled 280 walking arm 125 while walking, causes the steering column 230 to rotate, which causes the steering arm 298 attached at the distal end of the steering column 230 to pivot. Pivotal motion of the steering arm 298 is transmitted via tie rods 292, 295 to the wheel steering knuckles 282, 290, causing the wheel steering knuckles 282, 290 to pivot and the steering collars 285, 288 to rotate. Rotation of the steering collars 285, 288 causes the wheel hubs 260, 265 to pivot. Such pivoting of the wheel hubs 260, 265 allows front wheels 140, 142 to correspondingly pivot, thereby causing the vehicle 100 to follow a desired course. The steering column 230 may optionally contain one or more universal joints to allow it to deviate somewhat from a straight line. Riding steering may operate through the one or more universal joints to provide off-axis rotation between the steering column and the handlebar or steering wheel, which will allow these devices to be mounted with optimum regard to a driver while in the seated position.

In an alternative embodiment, the walking arm 125 may be configured to act directly upon the front wheel steering knuckles 282, 290. Regardless of whether the walking arm 125 acts on the steering column 230 or the front wheel steering knuckles 282, 290, the walking arm 125 acts as a steering lever to the walking driver and the vehicle will follow behind the driver using a hand throttle and electric power. Either embodiment may include a steering box, such as a rack and pinion assembly. Various combinations of tie rod assemblies can be used to connect the steering knuckles 282, 290 to the steering column 230 or walking arm 125.

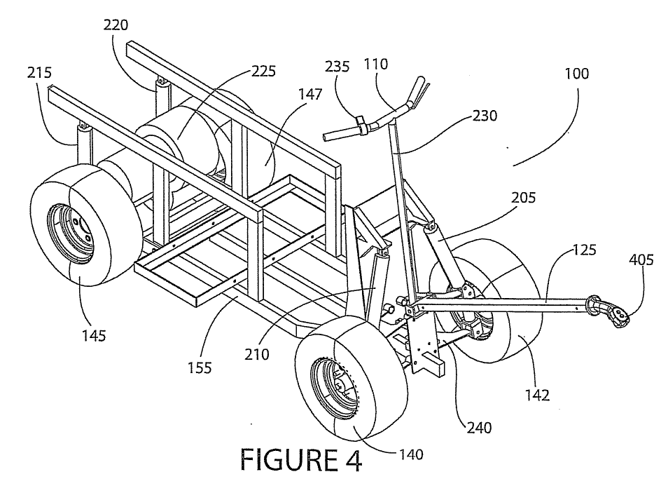

With reference to FIG. 4, in another embodiment the pivotally coupled 280 walking arm 125 is equipped with a control grip 405. The control grip 405 may include a plurality of switches and other controls to govern operation of the cart 100. The switches may be actuated conveniently by an operator's grip and finger action. The control grip 405 may be fixedly attached to the free end of the walking arm 125 and electrically coupled to an electronic controller (discussed below) that governs operation of the motor. A control grip 405 is preferred over a handlebar configuration because it is more easily grasped and managed by a pedestrian with one hand while walking ahead of the cart 100.

Non-limiting examples of alternative steering systems include rack and pinion and recirculating ball. In a rack and pinion system, rotation of the steering column 230 turns a pinion gear which moves a rack linearly. This linear motion applies steering torque to kingpins of the steered wheels via tie rods and the steering knuckles 282, 290. In a recirculating ball system, the rotating steering column 230 turns a large screw (i.e., “worm gear”) which meshes with a sector of a gear, causing it to rotate about its axis as the worm gear is turned. An arm attached to the axis of the sector moves a pitman arm, which is connected to a steering linkage and thus steers the wheels.

Advantageously, a cart 100 according to principles of the invention provides separate steering mechanisms for walking and riding. The walking mechanism, i.e., handle 125, is readily available for pedestrian use without need to adjust or reconfigure the mechanism, i.e., handlebars 110 (or a steering wheel) for riding use. Likewise, the riding mechanism, i.e., handlebars 110 (or a steering wheel), is readily available without need to adjust or reconfigure the mechanism, i.e., handle 125, for walking use.

Any compatible vehicle suspension system may be used with a cart 100 according to principles of the invention. The suspension system includes springs, shock absorbers and linkages that connect the wheels 140, 142, 145, 147 to the frame 155. The suspension system contributes to the vehicle's handling and attenuates road noise, bumps, and vibrations transmitted to the passenger compartment and vehicle occupants and cargo. The design of front and rear suspension of a car may be different. Illustratively, each front wheel 140, 142 may be mechanically linked to the frame by one or more stationary or movable linkages, such as upper and lower pivoting control arms 240, 245, 250, 255. Struts 205, 210 comprising springs to absorb impacts and dampers (e.g., shock absorbers) to dampen spring motion are connected to strut mounts 270, 275 and upper pivoting control arms 240, 245. The struts 205, 210 suppress road noise, bumps, and vibrations that are transmitted to the passenger compartment and vehicle occupants and cargo. As each front wheel 140, 142 may rise and fall on its own without affecting the opposite front wheel, the exemplary front suspension is an independent front suspension.

Referring now to FIG. 2B, a perspective view of components of an exemplary rear suspension and drive train for a dual mode of use vehicle according to principles of the invention is provided. The rear suspension includes a pivoting carriage 214 to which the drive train is attached. The carriage 214 is pivotally coupled to the frame 155 by a torsion bar 213. The torsion bar 213 may be a hinged joint or a torque biased spring configured to urge the end of the carriage 214 opposite the torsion bar away from the frame 155. Struts 215, 220 comprising springs to absorb impacts and/or dampers (e.g., shock absorbers) to dampen motion are each connected at one end to the frame 155 and at the other end to the end of the carriage 214 opposite the torsion bar away from the frame 155. The struts 215, 220 suppress road noise, bumps, and vibrations that are transmitted to the passenger compartment and vehicle occupants and cargo.

The invention is not limited to any particular drive train, i.e., the components between the motor 222 and driving wheel 212 or wheels 211, 212. Any drive train suitable for transmitting rotational force from the motor 222 to a driving wheel 212 or wheels 211, 212 may be utilized and is intended to come within the spirit and scope of the invention. In the exemplary embodiment depicted in FIG. 2B, the motor 222 is a direct current, variable speed, reversible electric motor (e.g., a 3.0 hp, 48 V DC electric motor transaxle). Operation of the motor 222, including speed and direction, is governed by an electronic controller, as discussed more fully below. The wheels are operably coupled to an axle 223. The motor is operably coupled to the axle by a transmission 225. The transmission may comprise a plurality of pulleys and a continuous belt contained within lower and upper housings 224, 225 with a driving pulley attached to the shaft of the motor and a driven pulley connected to the axle 223. Alternatively, a gear train or gear box contained within lower and upper housings 224, 225 and associated with the motor 222 shaft and axle 223 may transmit force from the motor 222 to the axle 223. A mechanical or electromechanical clutch, a fluid flywheel, or a torque converter may optionally be provided to controllably engage and disengage the transmission. The motor 222 in cooperation with the transmission 225 propels the vehicle at a walking or riding pace, depending upon the mode of use and speed of operation.

To manage speed, a speed sensor, such as a Hall effect sensor 690 is operably coupled to the motor shaft. The Hall effect sensor 690 provides a non-intrusive measurement and is available in a small IC package that combines the sensor and signal-conditioning circuit. Analog output voltage from the sensor 690 is input directly into the controller's ADC.

In the riding mode of vehicle operation, brake controls may be actuated by a foot-operated brake pedal on the vehicle floor or a hand-operated brake lever mounted on the handlebar or near the steering wheel. An alternative embodiment provides a hand-lever parking brake. In addition, these brake devices may also engage a mechanical parking brake by using a pull-cable linkage that includes an expansion spring 524 having a mechanical strength sufficient to engage the mechanical parking brakes without significantly extending the spring length.

In walking mode it may be desirable provide a mechanical parking brake that immediately engages if the driver releases a hand-on sensor 708. It may be desirable to require the driver to engage and lock a parking brake whenever the vehicle is not in motion. A mechanical parking brake override system is provided that uses the walking steering arm as a mechanical lever to actuate an override link cable. This cable and linkage assembly provides sufficient force to extend the expansion spring 524 and release the mechanical parking brake. As the walking steering arm is rotated downward from a near-vertical position, the override link cable causes the expansion spring 524 to extend and disengage the mechanical parking brake. If the walking steering arm is returned to the near-vertical position, the expansion spring 524 will reengage the brake.

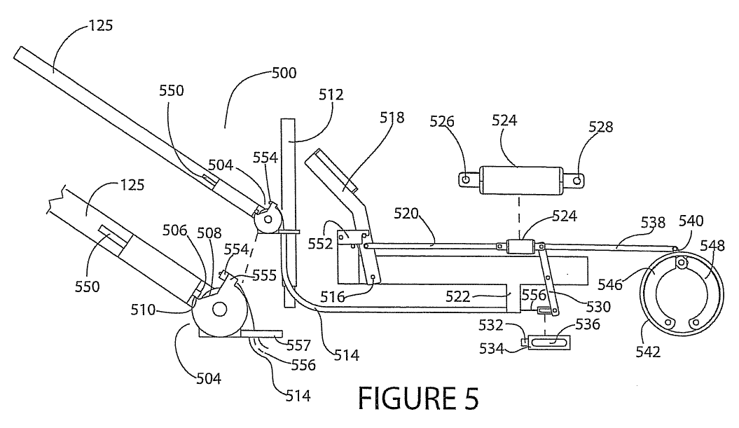

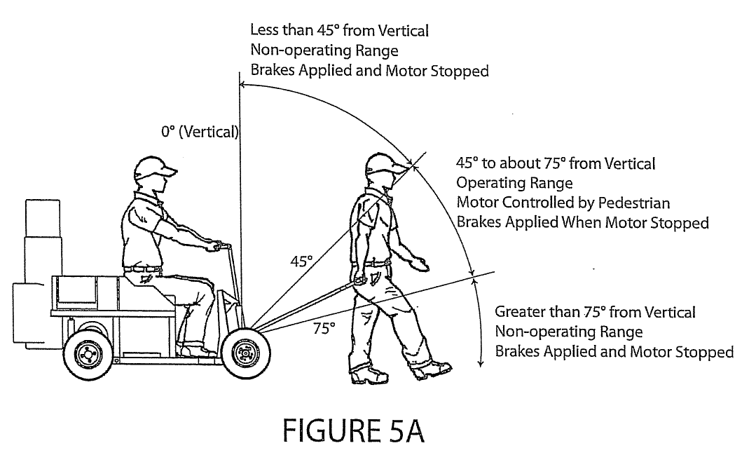

Referring now to FIG. 5, a plan view of components of an exemplary braking system for an exemplary dual mode of use vehicle according to principles of the invention, is provided. The exemplary braking system includes a foot pedal 518 connected via linkages 520 and 538 (e.g., brake cables) and an intermediate expansion spring 524 with pedal-side and brake-side connections 526, 528 to the actuator 540 of one or more drum brakes 542. A pivot mount 516, enables pivoting motion of the foot pedal 518. A lock 552, enables locking the pedal 518 in a depressed position. In riding mode, depressing the pedal 518 pulls the actuator 540, which urges the brake shoes 542, 548 against the inner walls of the drum brake 542, thereby generating frictional braking force. The expansion spring 524 regulates the maximum tensile force transmitted through the brake linkage 538. A parking brake may be electrically engaged whenever the throttle returns to the neutral of off position, or whenever the hand-on sensor 708 is activated.

For pedestrian braking, the pivoting walking arm 125 includes a releasable engagement pin 506 and a quick release switch 550. An override cable pull cam 504 is operably associated with walking arm 125, and particularly with the engagement pin 506. As the engagement pin 506 advances along the face 508 of the cam 504, it encounters a lip 510. Further advancement of the engagement pin 506 causes the cam 504 to rotate, which exerts tension on the override cable assembly 514, comprising a movable cable 556 in a concentric outer sheath. The ends of the outer sheath are secured to cable supports 522, 557. The cable 556 is operably coupled to a cam arm 555 via a cable stop collar 554. Pivoting motion of the cam arm 555 exerts or relieves tensile force on the cable 556. Pivoting motion of the walking arm,125 and engagement pin 506 against the lip 510 causes pivoting motion of the pull cam 504 and cam arm 555, which applies tension on the override cable assembly 514, which causes the cable 556 to move in the cable assembly 514.

A sliding joint 534 is attached at its neck 532 to the override cable assembly 514, or more particularly to cable 556. An elongated aperture 536 defines a range of free motion. Tension of the override cable 556 will not be transmitted to the pivoting linkage arm 530 until the range of free motion is exceeded, which is normally the non-operating range of rotation of walking arm 125. Releasing the quick release 550 activates the brakes when the walking arm 125 is in the operating position. The quick release may be electrically or mechanically actuated by the operator handle 130 or control grip 405 or motor controller 600.

With reference to FIG. 5A, the walking arm is configured to release the brakes in pedestrian mode while the walking arm 125 is within a determined operating range. The operating range may be defined by an angular position of the arm 125 relative to the horizontal, vertical or another reference plane. By way of example and not limitation, the operating range may be from a minimum angle (e.g., 15 to 60 degrees) from the vertical to a maximum angle (e.g., 60 to 85 degrees) from the vertical, although of course the minimum and maximum angles need not be limited to these ranges. In an exemplary embodiment, the operating range extends from about 45 to 75 degrees, providing a 30 degree range for operation of the vehicle. This range is within a normal holding position for an adult pedestrian.

The walking arm 125 has a plurality of electrically sensed positions that provide one or more inputs to the vehicle control logic. One or more sensors and/or switches may be provided to monitor angular position of the arm 125 and/or determine if the arm 125 is within operating range. Various electrical sensors may be used to detect the position of walking arm 125 and provide electrical input to the controller 600. For example, an on-off switch that senses a range of motion using a mechanical cam actuator, or a rotary sensor that electrically determines the axial position of the walking arm using a potentiometer or rotary encoder may be utilized. Analog and/or digital signals may generated by the sensors and/or switches. Such sensors may include any angular position sensors and/or switches that are known in the art and compatible with angular movement of the arm 125. The stowed position is a fixed mechanical position adjacent to or on the steering column axis. In the stowed position the walking arm 125 is held secure using a locking mechanism. The secure stowage of the walking arm 125 may be sensed by an on-off switch, which provides an electrical input to the vehicle control logic that is used as a condition to safely operate the vehicle in riding mode. The operating range as described above, is defined by an angular range extending where a driver typically holds the walking handle while walking ahead of the vehicle. The non-operating position is an angular range of motion extending upward between the stowage position and the beginning of the operating range. By signaling the controller to disable the throttle and, optionally, engage a parking brake, the non-operating positions prevents accidental operation of the vehicle as the driver rotates the walking steering arm from the stowage position to the operating position, and as the walking arm is dropped or otherwise allowed to pivot to the ground.

A preferred embodiment of a hand-on sensor 708 provides a mechanically or electrically actuated quick release device that releases the parking brake. This allows the expansion spring 524 to return to its original position and reengage the mechanical parking brakes. This provides an all-mechanical brake circuit, which may be preferable to relying upon all-electrical brake system. The quick release device may be located at either end of the linkage cable.

The handle 130 or control grip 405 of the walking arm 125 may be gripped by one hand of a person walking ahead of the vehicle. The gripped portion has a throttle control, brake control and a hand-on sensor 708, all of which provide electrical inputs to the motor controller 600 in walking mode. The controller 600 may be configured to require the hand-on sensor 708 to generate a signal corresponding to a detected hand to maintain control of the vehicle 100 at all times while walking. The hand-on sensor 708 on the handle 130 or control grip 405 may comprise a mechanical handle lever that activates an electromechanical switch or solid-state sensor, a non-contact proximity sensor or photo-electric device, or a push button situated on the handle. Operation of the vehicle in walking mode is provided by the vehicle control logic, which may require the following conditions to be met prior to operation: (i) the walking arm 125 may be in the operating position, (ii) the hand-on sensor 708 may be activated, and (iii) any telescoping or folding sections of the walking arm may be properly extended. Prior to any vehicle motion in walking mode, the driver's hand may engage the hand-on sensor 708, which is required as a logic condition prior to enabling vehicle motion. The hand-on sensor 708 may be interlocked with the throttle 616, 720 and control of a parking brake 610 to maximize convenient operation of the vehicle.

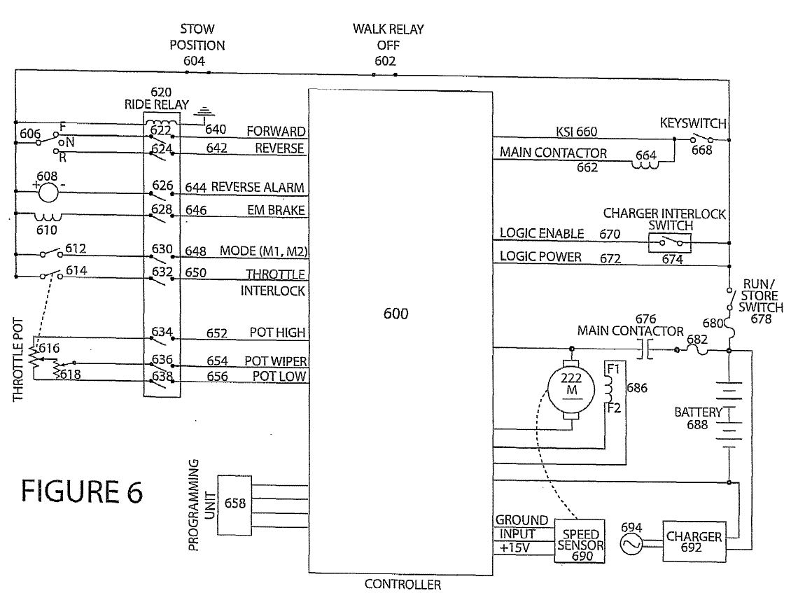

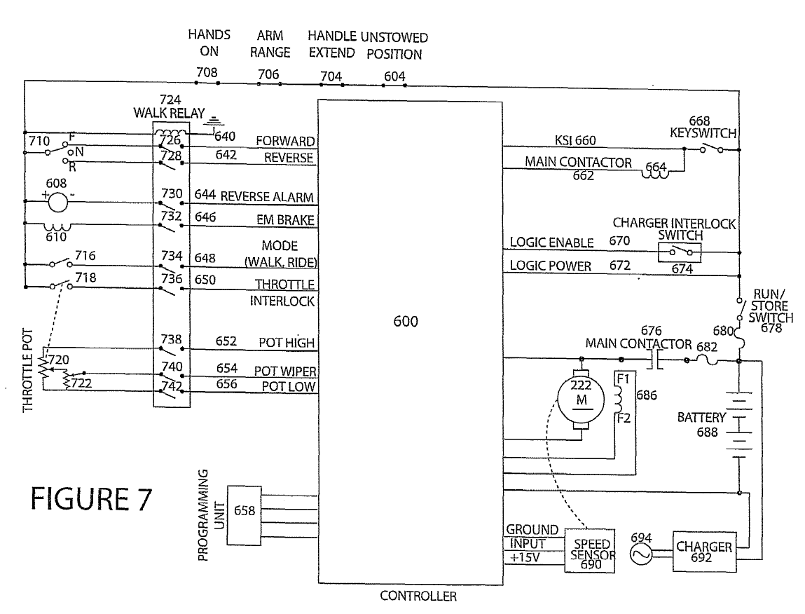

Referring now to FIGS. 6 and 7, high level schematic of components of an exemplary riding electronic control system for an exemplary dual mode of use vehicle according to principles of the invention, are provided. The controller 600 includes a central processing unit, discrete logical inputs and outputs allowing control or detection of logic states, analog outputs, a serial communications interface for system interconnect with programming and diagnostic devices, a clock/timer, volatile and/or nonvolatile memory for data and program storage, and one or more analog-to-digital converters. The motor controller 600 varies the drive output of motor 222 in response to an input signal from throttle controls 616, 618 and 720, 722. The motor controller may be a standard, commercially available electronic motor controller having reverse drive and braking functions. The motor controller is preferably a programmable controller of a type commonly used in forklifts and other industrial vehicle products. Such motor controllers are desirable because they can be custom configured to accommodate multiple speed modes, load compensation for maintaining constant speed when traveling up and down inclines, and anti-rolling functions. By way of example and not limitation, a suitable motor controller is a 48 V, 110 Amp Curtis 1266 electronic controller made by Curtis Instruments, Inc. of Mount Kisco, N.Y.

The exemplary motor controller has the following inputs: Motor Speed Sensor input, Throttle input, Battery Charger Interlock input, Reverse input, Forward input, Throttle Enable (interlock) input, Mode input, Keyswitch input, Run Enable input. The motor controller has the following outputs: Brake output, Reverse Alarm output, Main Contactor output.

One or more relays control inputs to the controller 600 for walk or ride mode functionality. For example, a ride relay 620 and a walk relay 724, or an integrated ride/walk relay, may enable inputs to the controller 600 for selecting ride or walk modes. Thus, in ride mode, the relay 620 allows inputs to the controller from ride mode controls and switches. In walk mode, the relay 724 allows inputs to the controller from walk mode controls and switches. In walk mode, the ride mode controls and switches do not influence the controller 600. Likewise in ride mode, the walk mode controls and switches may not influence the controller.

Control switches for operating the motor 222 to propel the vehicle may be provided at any convenient place on the vehicle. As illustrated in the schematics of FIGS. 6 and 7, a mode control switch integrated with the walking arm 125 provides a signal that alerts the controller 600 to walking mode or riding mode. When the arm 125 is in the vertical stow position 604, riding mode is indicated and the walk relay 724 is off 602 and the corresponding walk mode switch 716 and relay 734 are in an open state. When the arm 125 is unstowed 604, in extended 704, walking operational range 706, within a pedestrian operator's hand 708, walking mode is indicated and the ride relay 620 is off. The maximum attainable speed in walking mode is less than the maximum allowable speed in riding mode.

Switch 708 is an electrically linked dead man's switch, provided to prevent locomotion when released, such as if the human operator releases the arm 125 in walking mode or becomes incapacitated. The switch 708 must be actuated to complete a circuit between the battery 688, through the controller 600 to the electric motor 222.

A three position direction switch 606, 710 is provided on the console 115 and on the walking arm controller (i.e., the handle 130 or control grip 405). The direction switch 606, 710 conveniently has a forward drive position, a reverse drive position, and an intermediate neutral position. The direction switch 606, 710 is operable to reverse the polarity of the battery 688 voltage applied to the DC motor 222 to reverse the motor rotation.

The motor 222 is powered by one or more rechargeable batteries 688. The preferred type of battery is deep cycle, such as a deep-cycle lead-acid battery designed to deliver a consistent voltage as the battery discharges. The motor's field connections (F1 and F2) 686 determine the direction of vehicle travel with the forward direction selected.

Throttle control is achieved through a potentiometer that is responsive to rotation, translation or other manipulation by a user. Various throttles may be used with the controller 600, including potentiometers that provide a variable resistance dependent upon position, which is used as an input to the controller. In a preferred embodiment, two potentiometers in series comprise each of the walk and ride throttle controls 616, 618 and 720, 722. One potentiometer 616, 720 serves as the throttle, while the other 618, 722 provides trim control 618, 722 that limits the output to a maximum voltage (e.g., a maximum of less than 5 volts). The throttles 616, 720 are activated in a single direction of rotation and are biased (e.g., spring-returned) to a neutral or off-position when released by the driver. Although the controller 600 limits the maximum speed in walking mode, the trim control 618, 722 further reduces the maximum speed by limiting the throttle movement or reducing the electrical output of the throttle potentiometer. The benefit of trim control 618, 722 is that a slower walking person may reduce the maximum speed and still fully engage the throttle 616, 720, which provides the driver with a repeatable and easy to use speed control device adjusted to an individual pace of walking. This speed trim control 618, 722 can be located on the walking arm 125 and on the vehicle console 115. Controller 600 output to the motor 222 is possible only when the throttle interlock input 614, 718 for the active throttle is engaged. The controller receives a voltage signal at the potentiometer wiper input 654, with vehicle speed increasing with increased throttle voltage. The voltage source and return to the throttle is provided by the controller, with potentiometer high 652 providing a current limited 5V source to the throttle, and potentiometer low 656 providing a return path. The ride and walk relays 620, 724, disrupt or complete connections 634-638, 738-742 between the throttles 616-618, 720-722, depending upon the mode of operation. Thus, the ride throttle 616-618 functions in ride mode, while the walk throttle 720-722 functions in walk mode. A throttle on-off switch (e.g., throttle interlock 614, 718) is provided at the beginning of the throttle's range-of-rotation to provide an additional input to the vehicle control logic or motor controller that protects against unintended vehicle movement.

In the exemplary embodiment, a plurality of switches are provided to controllably enable and disable operation. A key switch 668 located on the console is connected to a key switch input 660 enables and disables operation. A run/store switch 678 located in an out-of-the-way location also enables and disables operation, but is left on except when the vehicle will be stored or is being towed. The key switch 668 and the run/store switch 678 provide current to drive the motor 222 via the controller 600.

The controller 600 provides three drivers for an emergency brake 646, a reverse alarm 644, and main contactor 662. These three outputs are low-side drivers, configured to controllably energize inductive coils, a piezoelectric reverse alarm or a similar component. The controller may include voltage drivers to limit these outputs to a determined percentage of system voltage and coil suppression diodes to protect drivers from inductive spikes generated at turn-off. The main contactor coil 664 activates and deactivates the main contactor 676, which allows the controller 600 and motor 222 to be connected and disconnected from the battery 688. A fuse 682 is provided between the battery 688 and main contactor 664. Through the main contactor coil 664 in concert with the main contactor 676, battery power can be removed from the drive system if a controller 600 or other wiring fault is detected. The reverse alarm driver 644 drives a reverse signal beeper or piezoelectric buzzer 608 that operates when the vehicle is traveling in reverse. The emergency brake driver 646 drives a brake coil 610 that releases the brakes when the vehicle is commanded into motion.

Programmable parameters such as current limits, acceleration and deceleration rates, braking parameters, and speed parameters may be set by interfacing the controller 600 with a programming unit 658 via a serial interface or other compatible communication link. Programming instructions and data may be stored in a PROM, EEPROM or other volatile memory in the controller. For riding mode, the exemplary motor controller 600 has the following programmable parameters: Main Current Limit, Acceleration Rate (e.g., the time, in seconds, for the controller to accelerate from 0% output to 100% output), Deceleration Rate (e.g., the time, in seconds, for the controller to reduce the average voltage at the motor armature output from 100% PWM to 0% PWM), Brake Minimum (e.g., the max brake actuating current at low speeds), Brake Maximum (e.g., the max brake actuating current at low speeds), Brake Map (e.g., a percentage of the brake actuating current between the BRAKE MIN and BRAKE MAX values, at a midpoint that is halfway between the BRAKE END and BRAKE START speeds), Brake Start (e.g., vehicle speed at which the brake map starts to increase from the BRAKE MIN value), Brake End (e.g., the vehicle speed at which the brake map reaches the BRAKE MAX value), Forward Speed (e.g., maximum walking speed in riding mode), and Forward Field Minimum (e.g., the minimum field current in riding mode ). For walking mode, the motor controller has the following programmable parameters: Brake Minimum (e.g., the max brake actuating current at low speeds), Brake Maximum (e.g., the max brake actuating current at low speeds), Brake Map (e.g., a percentage of the brake actuating current between the BRAKE MIN and BRAKE MAX values, at a midpoint that is halfway between the BRAKE END and BRAKE START speeds), Brake Start (e.g., vehicle speed at which the brake map starts to increase from the BRAKE MIN value), Brake End (e.g., the vehicle speed at which the brake map reaches the BRAKE MAX value), Forward Speed (e.g., maximum walking speed in walking mode), and Forward Field Minimum (e.g., the minimum field current in walking mode).

A battery charger interlock 674 may prevent motor operation during charging. A battery charger 692, which may be external to or installed on the vehicle 100, converts AC utility power 694 to DC current output for charging the batteries 688. The output current depends upon the state of the batteries 688. The charger monitors the voltage of the batteries 688, temperature and time under charge to determine a charge current. Charging terminates when a combination of the voltage indicates that the batteries 688 are fully charged. The voltage across the batteries 688 increases slowly during the charging process, until the batteries 688 are fully charged. After that, the voltage decreases, which indicates that the batteries 688 are fully charged. Optionally, when the batteries are charged up to about 85% of its maximum capacity, the charger 692 may switch to trickle charging to charge the batteries 688 slowly to full capacity.

An electronic brake control may be provided in various embodiments as a brake potentiometer or coil (e.g., relay) 610, a brake on-off switch, a combination brake device combining a potentiometer and an on-off switch. An alternate embodiment of the brake control is to utilize a single electrical device and to mechanically actuate the brake sensor using one or more brake cables. The brake control is activated in a single direction of rotation and/or translation and is spring returned to a neutral or off-position when released by the driver. The brake control may be a potentiometer or an on-off switch that provides input to the vehicle control logic or motor controller and may include an additional on-off switch at the end of its range-of-rotation that engages a parking brake. A mechanical or electrical locking device at the end of the mechanical range-of-motion may maintain the vehicle parking brake. A further embodiment of the brake sensor uses the throttle sensor input to compare the driver's commanded vehicle speed with the actual vehicle speed. This comparison may occur in the vehicle control logic or the motor controller. When it is determined that the vehicle is operating at a speed greater than the speed commanded by the throttle sensor, various known braking systems may be applied such as regenerative braking, armature-field motor braking, wheel shaft drum or disk brakes, or motor shaft drum or disk brakes.

Actuation of a throttle control or brake control can be provided by a rotating hand-grip device or a thumb-finger-lever device. The throttle control and brake control may be combined into a single operator point of control on the walking arm 125, which may include two separate potentiometers and two separate on-off switches operating about a common rotational axis. The throttle and brake controls typically actuate in opposite directions of rotation. Two separate biasing means (e.g., springs) and mechanical stops provide a neutral or off-position between the throttle range-of-rotation and the brake range-of-rotation. Placing the throttle and brake onto a common rotational axis provides an operator with ability to use one hand or a finger to control all vehicle movement.

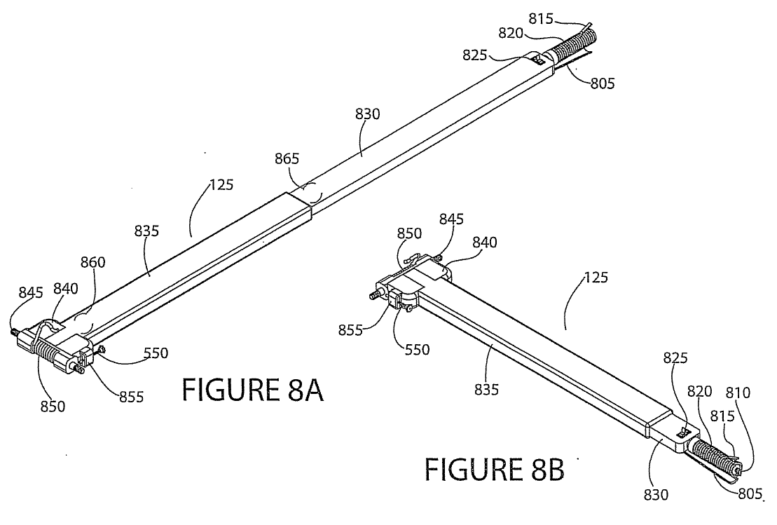

A telescopic walking arm 125 is conceptually illustrated in FIGS. 8A and 8B. A smaller diameter sliding section 830 is telescopically engaged by a base section 835 of the walking arm. The extended walking arm 125 is rigid. Various mechanical and electromechanical locking devices may be provided to lock the sections 830, 835 in an extended or collapsed orientation. The extended arm is long enough to maintain a distance between a pedestrian user and the front of the vehicle. Thus, a buffer distance of one foot or more may remain between the heels of a pedestrian user in a normal stride and all structures of the vehicle, including but not limited to the front wheels. Extended lengths of three feet or more are preferred.

The walking arm includes various controls, some of which may be utilized for both walking and riding modes of use. For example, a three-way forward-neutral-reverse switch 825 is disposed on the based section in a position accessible to both pedestrian users and drivers. Thus, when the user is walking, the user may control direction of travel using the forward-neutral-reverse switch 825 positioned within reach of the control grip 820. Likewise when the walking arm 125 is collapsed and pivoted upright for driving mode use, the driver may control direction of travel using the forward-neutral-reverse switch 825, which is then well within reach of a seated driver. Other controls on the control grip 820 include a hand-on switch also known as a dead man's switch 805, a throttle control 815 and a throttle trim control 810. Locomotion is disabled and braking is applied unless the dead man's switch 805 is depressed, the walking arm 125 is within operational range, the forward-neutral-reverse switch 825 is in forward or reverse position, and the throttle 815 is depressed.

Various sensors and switches may be included on or within the walking arm 125 to detect orientation. For example, one or more safety switches 860, 865 within the telescopic sections 830, 835, may sense when the walking arm 125 is fully extended and when the walking arm is fully collapsed. An angular sensor such as one or more positional switches, a rotary potentiometer or a rotary encoder may be included in an electronics compartment 840 adjacent the axle 845 and configured to generate an output signal corresponding to angular orientation of the walking arm 125 relative to the axle 845 or another reference axis. Riding mode may be disabled when the walking arm 125 is not fully collapsed and pivoted and locked in a substantially vertical orientation for riding mode. Likewise, walking mode may be disabled when the walking arm 125 is not fully extended and pivoted into operational range.

Springs and dampers may be provided to facilitate handling and restraint of the walking arm 125. By way of example and not limitation, a biasing means such as a torsion spring 850 may exert a torque towards the vertical position, the magnitude of the torque increasing with pivoting away from the vertical position. The force should be sufficient to counteract at least some of the downward force due to the weight of the arm. Thus, the torsion spring 850 facilitates holding the walking arm 125 in operational range for an extended period of time. Additionally, if a user drops the arm, the counteracting torque will reduce the impact, i.e., net downward force, of the arm 125 against the ground, a foot or some other obstacle. The mitigated impact will help protect the integrity of the arm and its components, while preventing serious damage to impacted feet and ground surfaces. To further dissipate kinetic energy of the moving arm 125, one or more shock absorbers may operably couple the arm 125 to the frame or another supportive structure.

Adjacent to the axle 845, a shoulder 855 supports the optional quick release switch 550. The quick release switch may be manually or electrically actuated to release or actuate fail safe braking when the walking arm 125 is in operational position.

While the principles of the invention may apply to a multi-passenger vehicle and the invention is not limited to any particular passenger configuration, in a preferred exemplary embodiment, a vehicle according to principles of the invention is configured with one seat for one person. In the preferred embodiment, the area occupied by the preferred embodiment is approximately ½ the area occupied by a conventional two-person golf cart. Thus, a vehicle storage area at a golf club may accommodate twice as many of the single person vehicles according to the invention than conventional two-person golf carts. This provides many advantages. The opportunity for revenue generation is greater. It is also far more efficient to provide a single-person golf cart to a single golfer than it is to provide a two-person golf cart to a single golfer. Additionally, a golf cart per person provides added convenience, allowing each golfer to follow their own route, at their own pace, and carry their clubs to each of their shots, without inconveniencing other players in a group.

By way of example and not limitation, the overall length of a single person vehicle according to principles of the invention with the walking arm in the stowed upright position is about 48 to 60 inches, and the overall width is approximately 30 to 36 inches, providing an overall area between 1440 in² to 2,160 in². In contrast, a conventional two-person golf cart has a length of about 94 inches, a width of about 48 inches, occupying an area of over 4,400 in².

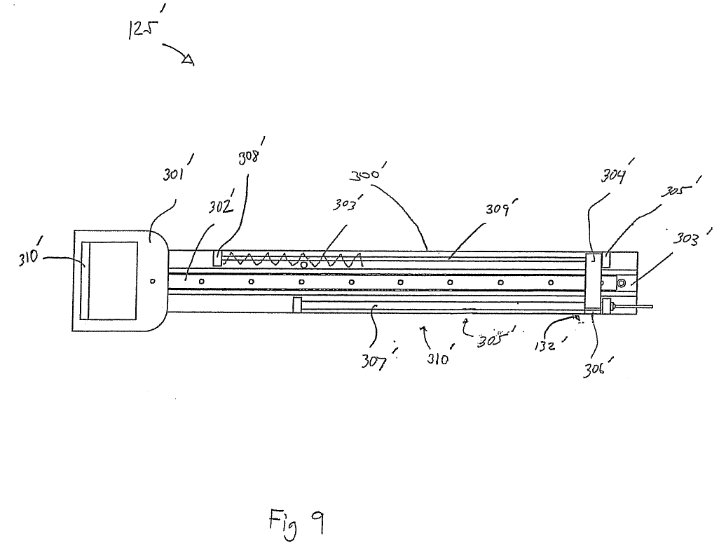

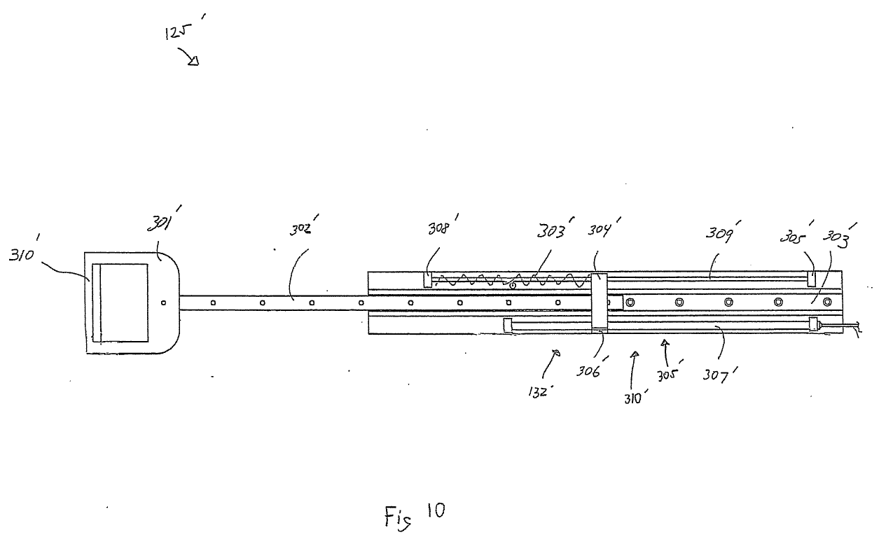

With reference to FIGS. 9-11, an alternative embodiment of the vehicle 100′ in accordance with the present invention is now described. In this embodiment, a walking steering apparatus 125′ is coupled to the steering assembly (tie rods 292′, 295′, wheel steering knuckles 282′, 290′, and steering collars 285′, 288′) for the walking mode of use. The walking steering apparatus 125′ comprises an extendable arm 300′ and a handle 301′ coupled thereto. As will be explained in greater detail below, a walking throttle 132′ is coupled to the extendable arm 300′ and the motor 222′ to control the motor in the walking mode of use based upon extension and retraction of the extendable arm 300′.

A lockout switch 310′ is carried by the handle 301′ and coupled to the controller 600′ to enable the walking throttle 132′ based upon contact with a user's hand. The lockout switch 310′ may be a pressure activated switch, a proximity sensor, or any other suitable sensor that detects contact with a user's hand. The lockout switch 310′ may be coupled to the controller 600′ via a wired or wireless connection. A wired connection between the lockout switch 310′ and the controller 600′ may be facilitated by a coiled wire or a wire/pulley/spring system, to accommodate the change in length of the walking steering apparatus 125′ as the extendable arm 300′ extends and retracts.

If a wireless connection is used to couple the lockout switch 310′ to the controller 600′, the lockout switch 310′ may have a transmitter that operates at a unique frequency so that multiple vehicles 100′ in accordance with the present invention may be used in close proximity. Those skilled in the art will appreciate that the lockout switch 310′ need not be carried by the handle 301′ and may instead be carried at other locations on the walking steering apparatus 125′.

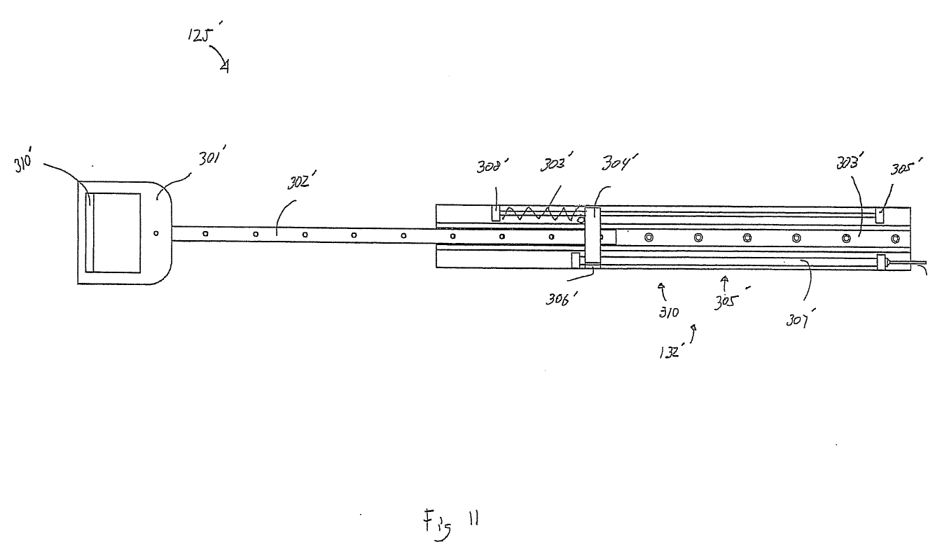

In the illustrated embodiment, the extendable arm 300′ comprises an outer telescoping member 303′ at least partially surrounding an inner telescoping member 302′. The inner telescoping member 302′ is movable with respect to the outer telescoping member 303′ from a retracted position (FIG. 9) to an extended position (FIG. 11). It should be understood that there may be any number of telescoping members and that the extendable arm 300′ is not limited to any specific number thereof. A spring 303′ coiled around a spring guide rod 309′ acts as a biasing member and is coupled to the extendable arm 300′ to bias the inner telescoping member 302′ in a retracted position. Of course, different biasing members other than the spring 303′ may be used.

The walking throttle 132′ includes a potentiometer 305′ coupled to the controller 600′. The potentiometer 305′ comprises a body 307′, and an external actuator 306′ that acts as a throttle sensor to detect extension and retraction of the extendable arm 300′. Those skilled in the art will appreciate that any suitable throttle sensor may be used instead of, or in addition to, the potentiometer 305′. Moreover, although the potentiometer 305′ is illustratively a linear potentiometer, other types of potentiometers may be used.

An actuator block 304′ is coupled to the inner telescoping member 302′ and to an external actuator 306′ of the potentiometer 305′. As the inner telescoping member 302′ extends and retracts with respect to the outer telescoping member 303′, the actuator block 304′ moves the external actuator 306′ with respect to the body 307′ of the potentiometer 305′. Movement of the external actuator 306′ with respect to the body 307′ causes a change in the electrical resistance of the potentiometer 305′ and thus in the voltage across the potentiometer as read by the controller 600′.

When the extendable arm 300′ is in the fully retracted position, the actuator block 304′ contacts a retraction stop 305′. In this fully retracted position, the voltage across the potentiometer 305′ is typically 0.0 volts. When the extendable arm 300′ is in the fully extended position, the actuator block 304′ contacts an extension stop 308′. In this fully extended position, the voltage across the potentiometer 305′ is typically 5.0 volts. Of course, the potentiometer 305′ may provide a voltage drop in a range of 0-10 volts, or any other suitable range. As explained above, the controller 600′ then varies the drive output of the motor 222′ in response to the signals from the walking throttle 132′ (the voltage across the potentiometer 305′).

The potentiometer 305′ also acts as a walking brake 310′ to control the braking system during the walking mode of use and based upon extension and retraction of the extendable arm 300′. This walking brake 310′ is coupled to the controller, which in turn is coupled to the braking system. As explained in greater detail above, the controller actuates the brakes based upon the walking brake 310′ (and thus the voltage across the potentiometer 305′).

When the vehicle 100′ is in the walking mode of use, and the extendable arm 300′ is in the operational position, a user may grasp the handle 301′ and begins to walk. As the user walks, the inner telescoping member 302′ extends relative to the outer telescoping member 303′. This moves the actuator block 304′, which in turn moves the external actuator 306′ with respect to the body 307′ of the potentiometer 305′. This changes the voltage drop across the potentiometer 305′, which is read by the controller 600′. The controller 600′ then adjusts the drive output of the motor 222′ based upon the voltage drop across the potentiometer 305′, thereby causing the vehicle 100′ to follow behind the user pulling the handle 301′ at a pace that matches the user's walking speed.

The extendable arm 300′ need not be in the fully extended position. Instead, it may be only partially extended, and the controller 600′ may adjust the drive output of the motor 222′ to match the user's walking speed.

If the user slows down his walking speed, the inner telescoping member 302′ may retract relative to the outer telescoping member 303′. The controller 600′ may then adjust the drive output of the motor 222′ downward to match the new walking speed of the user. In some situations, the slowdown of the user's walking speed may be so great that the controller 600′ may actuate the braking system. Actuation of the braking system may be triggered by the voltage across the potentiometer 305′ being above or below a threshold value, by a quick change in the voltage across the potentiometer 305′, or by any other suitable condition. Of course, if the user stops walking, the controller 600′ may actuate the braking system to bring the vehicle 100′ to a stop.

As also explained above, the walking steering apparatus 125′ is movable from an operational position to a stowed position. The walking throttle 132′ and the walking brake 310′ are disabled when the walking steering apparatus 125′ is in the stowed position.

A reverse switch (not shown) may be carried by the extendable arm 300′, for example on the handle 301′. When the reverse switch is activated, the controller 600′ causes the motor 222′ to operate in a reverse direction based upon extension and retraction of the extendable arm 300′ (for example, as a user pushes extendable arm to thereby cause it to retract, the vehicle 100′ will move backwards, and if a user pulls forward on the extendable arm to thereby cause it to extend, the vehicle 100′ may brake).

Those other elements of this embodiment not specifically described are similar to those of the embodiments above indicated without prime notation and thus require no further discussion herein.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A vehicle for riding and walking modes of use, the vehicle comprising:
a frame;
at least one seat coupled to said frame;
a plurality of wheels rotatably coupled to said frame;
at least one motor for driving at least one wheel of said plurality thereof;
a steering assembly coupled to at least one wheel of said plurality thereof;
a riding steering apparatus coupled to the steering assembly for the riding mode of use;
a riding throttle coupled to said at least one motor for the riding mode of use;
a walking steering apparatus coupled to said steering assembly for the walking mode of use and comprising an extendable arm; and
a walking throttle coupled to said extendable arm to control said at least one motor for the walking mode of use based upon extension of said extendable arm.

2. The vehicle of claim 1 wherein said extendable arm comprises a plurality of telescoping members.

3. The vehicle of claim 1 wherein said walking steering apparatus further comprises a biasing member for biasing said extendable arm in a retracted position.

4. The vehicle of claim 1 wherein said walking throttle comprises a throttle sensor coupled to said extendable arm to detect extension thereof.

5. The vehicle of claim 4 wherein said throttle sensor comprises a potentiometer.

6. The vehicle of claim 1 further comprising a lockout switch carried by said walking steering apparatus to enable said walking throttle based upon contact with a user's hand.

7. The vehicle of claim 1 wherein said walking steering apparatus is movable from a stowed position to an operational position; wherein said riding throttle is disabled when said walking steering apparatus is in the operational position; and wherein said walking throttle is disabled when said walking steering apparatus is in the stowed position.

8. The vehicle of claim 1 further comprising a controller coupled to said riding throttle, said walking throttle, and said at least one motor; and wherein said controller limits a speed of said at least one motor based upon the mode of use.

9. The vehicle of claim 1 further comprising:
a braking system;
a riding brake coupled to said braking system for the riding mode of use; and
a walking brake coupled to said extendable arm to control said braking system for the walking mode of use and based upon extension of said extendable arm.

10. The vehicle of claim 9 wherein said walking steering apparatus is movable from a stowed position to an operational position; wherein said riding brake is disabled when said walking steering apparatus is in the operational position; and wherein said walking brake is disabled when said walking steering apparatus is in the stowed position.

11. The vehicle of claim 9 further comprising a controller coupled to said braking system; wherein said riding brake is electrically coupled to said controller; and wherein said walking brake is electrically coupled to said controller.

12. The vehicle of claim 9 wherein said braking system comprises a regenerative braking system; and further comprising a rechargeable power supply carried by said frame and coupled to said regenerative braking system.

13. The vehicle of claim 9 wherein said braking system comprises a friction braking system.

14. The vehicle of claim 1 further comprising:
a riding forward-neutral-reverse switch carried by said frame and coupled to said at least one motor; and
a walking forward-neutral-reverse switch carried by said walking steering apparatus and coupled to said at least one motor.

15. The vehicle of claim 1 wherein said frame has a front end and a rear end; wherein said plurality of wheels comprises a pair of rear wheels carried by the rear end, and a pair of front wheels carried by the front end; and wherein said steering assembly is coupled to said pair of front wheels.

16. The vehicle of claim 15 wherein said at least one motor drives said pair of rear wheels.

17. A vehicle for riding and walking modes of use, the vehicle comprising:
a frame;
at least one seat coupled to said frame;
a plurality of wheels rotatably coupled to said frame;
at least one motor for driving at least one wheel of said plurality thereof;
a steering assembly coupled to at least one wheel of said plurality thereof;
a riding steering apparatus coupled to the steering assembly for the riding mode of use;
a riding throttle coupled to said at least one motor for the riding mode of use;
a walking steering apparatus coupled to said steering assembly for the walking mode of use and comprising an extendable arm including a plurality of telescoping members;
a walking throttle coupled to said extendable arm to control said at least one motor for the walking mode of use based upon extension of said extendable arm;
a braking system;
a riding brake coupled to said braking system for the riding mode of use; and
a walking brake coupled to said extendable arm to control said braking system for the walking mode of use and based upon extension of said extendable arm.

18. The vehicle of claim 17 wherein said walking steering apparatus further comprises a biasing member for biasing said extendable arm in a retracted position.

19. The vehicle of claim 17 wherein said walking steering apparatus is movable from a stowed position to an operational position; wherein said riding throttle is disabled when said walking steering apparatus is in the operational position; and wherein said walking throttle is disabled when said walking steering apparatus is in the stowed position.

20. The vehicle of claim 17 wherein said walking steering apparatus is movable from a stowed position to an operational position; wherein said riding brake is disabled when said walking steering apparatus is in the operational position; and wherein said walking brake is disabled when said walking steering apparatus is in the stowed position.

21. A method of making a vehicle for riding and walking modes of use, the method comprising:
coupling at least one seat coupled to a frame;
rotatably coupling a plurality of wheels to the frame;
coupling at least one motor to at least one wheel of the plurality thereof;
coupling a steering assembly to at least one wheel of the plurality thereof;
coupling a riding steering apparatus to the steering assembly for the riding mode of use;
coupling a riding throttle to the at least one motor for the riding mode of use;
coupling a walking steering apparatus to the steering assembly for the walking mode of use and comprising an extendable arm; and
coupling a walking throttle to the extendable arm to control the at least one motor for the walking mode of use based upon extension of the extendable arm.

22. The method of claim 21 wherein the extendable arm comprises a plurality of telescoping members and a biasing member to bias at least one of the plurality of telescoping members in a retracted position.

23. The method of claim 21 further comprising positioning a lockout switch to be carried by the walking steering apparatus to enable the walking throttle based upon contact with a user's hand.

24. The method of claim 21 wherein the walking steering apparatus is movable from a stowed position to an operational position; wherein the riding throttle is disabled when the walking steering apparatus is in the operational position; and wherein the walking throttle is disabled when the walking steering apparatus is in the stowed position.

25. The method of claim 21 further comprising:
coupling a riding brake to a braking system for the riding mode of use; and
coupling a walking brake to the extendable arm to control the braking system for the walking mode of use and based upon extension of the extendable arm.

26. The method of claim 25 wherein the walking steering apparatus is movable from a stowed position to an operational position; wherein the riding brake is disabled when the walking steering apparatus is in the operational position; and wherein the walking brake is disabled when the walking steering apparatus is in the stowed position.
